(19) United States
(12) Patent Application Publication
(10) Pub. No.: US 2002/0038375 A1
(43) Pub. Date: Mar. 28, 2002

(54) Method and apparatus for distributing software and user terminal using the same

(75) Inventors: Teruhiro Yamada, Osaka (JP); Atsushi Maeda, Osaka (JP); Tsugufumi Matsuoka, Osaka (JP)

Correspondence Address: LYON & LYON LLP, 633 WEST FIFTH STREET, SUITE 4700, LOS ANGELES, CA, 90071, US

(73) Assignee: SANYO ELECTRIC CO., LTD.

(21) Appl. No.: 09/822,797

(22) Filed: Mar. 30, 2001

(30) Foreign Application Priority Data
Sep. 26, 2000 (JP) 2000-292104

(51) Int. Cl. G06F 15/16

(52) U.S. Cl. 709/231; 709/236

(57) ABSTRACT

A software distributing server in which software is downloaded in a smooth and stress-free manner. The software distributing server segments the software into a plurality of recombinable segment data, and registers them in a predetermined site. A link monitor supervises a link state between a user terminal and the site, and a data transmit-receive unit transmits unsent data to the user terminal every time a link is detected.

### BACKGROUND OF THE INVENTION

1. Field of the Invention

The present invention relates to a network system, and it particularly relates to a technology for transmitting software.

2. Description of the Related Art

In recent years, personal computers come rapidly into wide use in our ever technology-growing society, and competition of their performance becomes very severe. For example, recall that the standard capacity of a hard disk was of some 100 MB order a few years ago, but some 10 GB order becomes a standard of today for the hard disk of the same price range. Thus, a general user can store as much data as he/she wishes, so that the user need not pay attention so much to the remaining vacant storage of the hard disk.

Moreover, as the CPU performance and drawing capability are rapidly improved, a data size of software is also enlarged. The software is supplied not only in the form of recording media such as a CD-ROM or the like, but also oftentimes via communication such as the Internet or the like. Thanks to various high speed communication technologies developed in recent years as to the speed of the Internet communications, the stress accompanied by the downloading of the software tends to decrease.

However, the high-speed Internet communication is actually available to few people and is not a commonly shared technology yet. This is because the higher the speed of the Internet service is the higher the connection and usage fee therefor becomes, and special hardware needs to be purchased also. In particular, the telecommunication fees are extremely high in Japan, which is recently criticized by other countries, and thus there are a great number of users who feel stressed when downloading the software.

### SUMMARY OF THE INVENTION

The present invention has been made in view of the foregoing drawbacks, and an object thereof is to provide a technology by which to transmit software with further increased convenience and usability.

An aspect of the present invention relates a software distributing method. This is a method by which to distribute software to a user terminal, and which includes: decomposing the software into a plurality of recombinable segment data; registering a plurality of the segment data to a predetermined site; detecting linkage of the user terminal to the site; and transmitting each of a plurality of the segment data to the user terminal in a sequence every time the linkage is detected.

The segment data are those in which certain data are decomposed into smaller-size data. In a preferred embodiment, those are segment data bearing a format in which the original software can be reorganized by recombining them. Moreover, before the data are decomposed into segments, an encryption or data compression processing may be performed on the software. Moreover, a format of segment data may be so arranged that the software is allowed for installation only when all segment data are recombined.

By implementing this method, software having the large-capacity data therein can be downloaded in a manner that the user is unaware of the downloading thereof, so that it can be transmitted without causing a stress to the user.

Another aspect of the present invention relates to a software distributing apparatus. This apparatus is an apparatus which distributes software to a user terminal, and includes: a dividing unit which decomposes the software into a plurality of recombinable segment data; a site registration unit which registers a plurality of the segment data to a predetermined site; a link monitor which supervises a link state between the user terminal and the site; and a data transmission unit which selects unsent data from a plurality of the segment data every time the user terminal is linked to the site, and transmits the unsent data to the user terminal. This apparatus may be a server connected to the Internet.

The dividing unit may subdivide the software into a data size to the degree the user is unaware of the downloading thereof, and the data transmission unit may transmit a plurality of the segment data to the user terminal without notifying the user terminal of the data transmission.

Still another aspect of the invention relates to a user terminal. The user terminal includes: a link processor which establishes a link with a registered site of a plurality of segment data, every time the user terminal is linked to the Internet, where software is decomposed in a recombinable format; and a data receiving unit which downloads from the registered site at least a single set among a plurality of the segment data.

The link processor may establish a link with the registered site every time the user terminal accesses any of a plurality of Web pages included in a predetermined related site. The user terminal may further include: a data storage which stores installed software; and an installation processor which, when the data receiving unit downloads all of a plurality of the segment data, recombines the segment data and installs the recombined segment data to the data storage.

Moreover, any arbitrary combination of the above-mentioned structural components in the present invention as well as the structural components and expressions according to the present invention is still effective as an embodiment of the present invention when applied as or substituted between an apparatus, a method, a system and so forth.

Moreover, this summary of the invention does not necessarily describe all necessarily features so that the invention may also be sub-combination of these described features.

### BRIEF DESCRIPTION OF THE DRAWINGS

FIG. 1 illustrates an overall structure of a network system 10 according to an embodiment of the present invention.

FIG. 2 shows a structure of a software distributing server 14.

FIG. 3 shows a structure of a user terminal 12.

FIG. 4 shows a flow of encryption, decomposition and registration of the software in this order.

FIG. 5 shows a flow of the decomposition and registration of the software comprised of a plurality of functional modules.

FIG. 6 is a flowchart showing an operational procedure of the software distributing server 14.

FIG. 7 is a flowchart showing an operational procedure of the user terminal 12.

FIG. 8 is a screen example, displayed on the user terminal, to confirm with the user whether or not transmission of the segment data is permitted.

FIG. 9 is a screen example, displayed on the user terminal 12, to confirm whether or not the installation of software is permitted.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

In a network system described hereinafter, a principal objective thereof is to reduce burden such as stress placed on a user in the course of downloading software for a considerable time of duration. As a means for achieving the objective, a technique according to the present invention is utilized in which software data are divided or decomposed into portions of an appropriate small size so that the software data are downloaded to the degree that the user is almost unaware of a downloading operation. Moreover, as a means by which the user is almost unaware of a timing at which the downloading operation is actually performed, a method is implemented in which a user terminal and a server are linked automatically. Moreover, as another means by which the user is almost unaware of the downloading operation, the divided (decomposed) data are distributed to a plurality of Web pages, and these Web pages may be given an amusement value and a game-playing value.

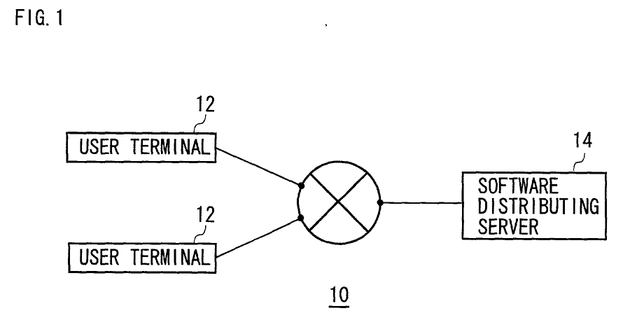

FIG. 1 illustrates an overall structure of a network system 10 according to an embodiment of the present invention. The network system 10 includes a plurality of user terminals 12 and a software distributing server 14. The software distributing server 14 is connected to a plurality of the user terminals 12 via the Internet. The software distributing server 14 may include a WWW server, and may be an exclusive-use server which exhibits the functions of the software distributing server according to the present invention. The software distributing server 14 can distribute software to the user terminals 12 by way of the Internet.

The software distributing server 14 can be realized, in terms of hardware, by a CPU, a memory or an LSI of an arbitrary computer and, in terms of software, by a software distributing functions loaded in a memory and a program with downloading functions, and so forth. The schematic diagram presented here, however, only shows the functional blocks which can be realized by interaction therebetween. Thus, it is to be understood by those skilled in the art that these functional blocks can be realized in various forms by the use of hardware only, software only or in combination thereof.

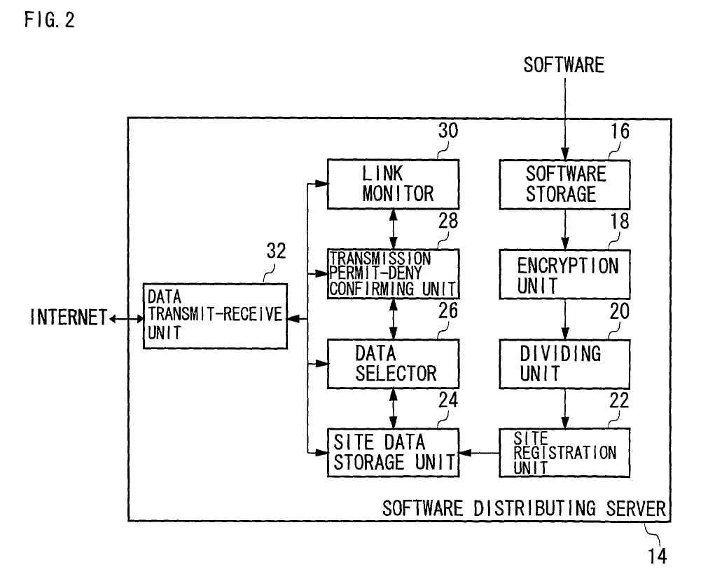

FIG. 2 shows a structure of the software distributing server 14. The software distributing server 14 comprises mainly a software storage 16, a software encryption unit 18 and a dividing unit 20. The software storage 16 stores software to be distributed. The software here may be not only programs executable by a computer but also include multimedia contents in which music, movie and so forth are data-encoded. The encryption unit 18 performs an encryption process on the software stored in the software storage 16. The encryption here includes a process which converts into data formats suitable for a transfer in the Internet communications, and a data compression process, and the like. The encryption is performed in a format on the condition that a dividing process will be carried out later. This format may be such that a recombination process, an unzip process, an installation process and the like are automatically performed when all of plural segment data become available.

The dividing unit 20 divides software into a plurality of segment data. The segment data are in a data format which can be combined again (recombinable). For example, the segment data may be such that they are recombinable only when all of plural segment data are present. As another format or form, for example, each of the plurality of segment data may have each function of the software. In this case, a scheme may be provided in a manner such that an installation becomes possible every time each segment data is acquired and, moreover a function is added one by one every time each segment data is installed.

The dividing unit 20 may subdivide the software into a data size to the degree that a user is unaware of the downloading thereof. For example, when the software is subdivided into a data size of some KB to some 10 KB order, the data thus subdivided can be downloaded instantaneously in theory. Thus, the stress accompanied by the software downloading can be significantly reduced.

The software distributing server 14 further includes a site registration unit 22, a site data storage unit 24 and a data transmit-receive unit 32. The site data storage unit 24 stores data such as hypertexts displayed on a Web site and a WWW server program. These data are stored on the assumption that they will be made public on the Internet. The site data storage unit 24 is affiliated with the data transmit-receive unit 32 so as to realize a function of the WWW server. Hereinbelow, a site made public in the Internet by the WWW server will be simply referred to as a “registered site”.

The site registration unit 22 registers a plurality of the segment data in the site data storage unit 24. In this case, the segment data can be acquired one by one every time the user accesses the registered site. Then, the user can acquire all of segment data by a predetermined number of accesses, so as to install the software for the first time. Thereby, repetition of accessing to the site can be expected.

The site registration unit 22 may register each of a plurality of the segment data in a plurality of web sites included in the registered site in a distributed manner. For example, the segment data are hidden in a plurality of the web sites, so that segment data may be acquired every time the use accesses these pages. For example, the segment data may be registered in web pages having the amusement value and game-playing value. Thereby, a presentation such as a treasure hunt or the like may be performed, so that the user can effectively browse around every corner of the site.

The software distributing server 14 further includes a data selector 26, a transmission permit-deny confirming unit 28 (also referred to as a transmission-permit confirming unit hereinbelow) and a link monitor 30. The link monitor 30 supervises a link state between the registered site and the user terminal 12. Then, every time a link is detected, each of a plurality of the segment data is transmitted, one at a time, to the user terminal 12.

Writing the segment data to the user terminal 12 without permission from the user is not a pleasant act to the user even though the segment data are confirmed safe. Thus, the transmission-permit confirming unit 28 confirms whether or not transmission of the segment data shall be permitted. The “permission or denial” of transmission in the transmission permit-deny confirming unit 28 takes a form of confirming it directly to the user and another form of confirming it based on data stored in the transmission permit-deny confirming unit 28.

For example, if all of a plurality of the segment data are not transmitted to the user linked, the permission or denial of the transmission may be confirmed directly with the user. Moreover, for example, if it is the first time access from the user, the permission or denial of the transmission may be confirmed directly with the user. A plurality of the segment data are transmitted only when the user permits its transmission.

The transmission permit-denial confirming unit 28 records the user's permission and denial of the transmission. By referring to this record, the transmission permit-denial confirming unit 28 can confirm permission or denial of the transmission from the next time when the link is established. Once the user permits the transmission of a plurality of the segment data, the segment data may be transmitted from the next time on without notifying the user. When the data are particularly subdivided into the data size to the degree that the user is unaware of the downloading thereof and thus the transmission is made without notifying the user from the second time on, the user does not feel stressed since he/she is unaware of the downloading.

The data selector 26 selects unsent data from a plurality of the segment data every time the user terminal 12 is linked to the registered site. The selected data are transmitted to the user from a data transmit-receive unit 32 via the Internet.

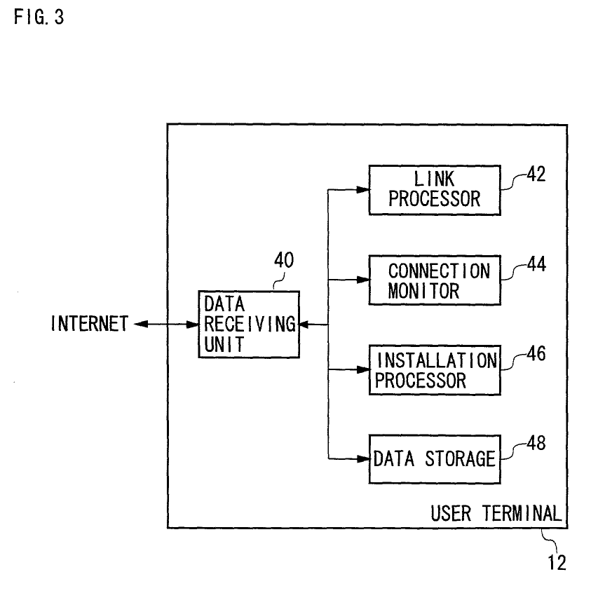

FIG. 3 shows a structure of the user terminal 12. The user terminal 12 is equipped with functions necessary for downloading the segment data from the software distributing server 14, in the form of hardware and software.

The user terminal 12 is mainly comprised of a data receiving unit 40, a link processor 42 and a connection monitor 44. The data receiving unit 40 downloads a plurality of the segment data from a registered site. The connection monitor 44 supervises whether or not the user terminal 12 is connected to the Internet. When connection to the Internet is detected, the link processor 42 establishes a linkage with the registered site. For example, software by which a link between the user terminal 12 and the registered site is established every time the user terminal 12 is connected to the Internet may be activated.

According to the present embodiment, the link to the registered site is established based on whether or not the user terminal 12 is connected to the Internet. According to another embodiment, the link to the registered site may be established based on whether or not the user terminal 12 is accessed to a predetermined related site. The related sites are operated mainly by an external WWW server. A plurality of home pages may be designated as the related sites, so that whenever the user reads these home pages, the link to the registered site is established in a non-display manner. For example, suppose that a plurality of companies affiliates in campaigning for events or products, then arrangement may be such that the segment data in which data for a campaign song are decomposed are automatically downloaded whenever the user visits home pages of these companies.

The user terminal 12 further includes a data storage 48 and an installation processor 46. The data storage 48 stores software which has been installed. The installation processor 46 installs the software in the data storage 48. When all segment data are stored in the data storage 48, the installation processor 46 recombines these segment data. Then, the installation processor 46 installs the recombined software in the data storage 48 in a manner such that its full function of the software can be exhibited. If the software is encrypted, the installation processor 46 decodes the encrypted software. If the software is compressed, the installation processor 46 unzips the compressed software.

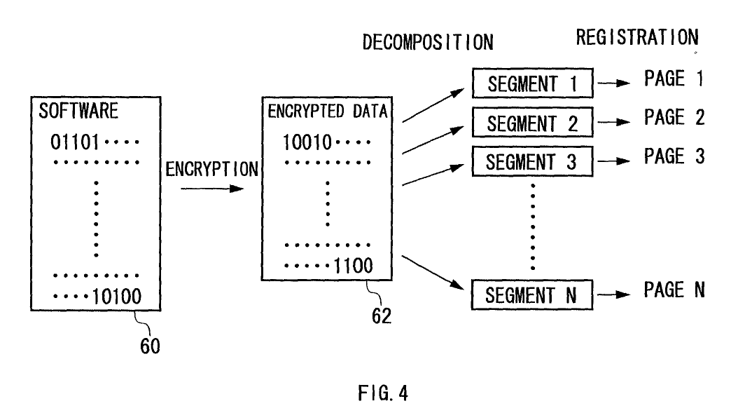

FIG. 4 shows a flow of encryption, decomposition and registration of the software in this order. First of all, software 60 is encrypted by the encryption unit 18 so as to be converted to encrypted data 62. The encrypted data 62 may be data in which the software 60 is compressed. The encrypted data 62 are decomposed into a plurality of segment data 1 to N by the dividing unit 20. A plurality of the segment data 1 to N are registered in a plurality of Web pages 1 to N by the site registration unit 22.

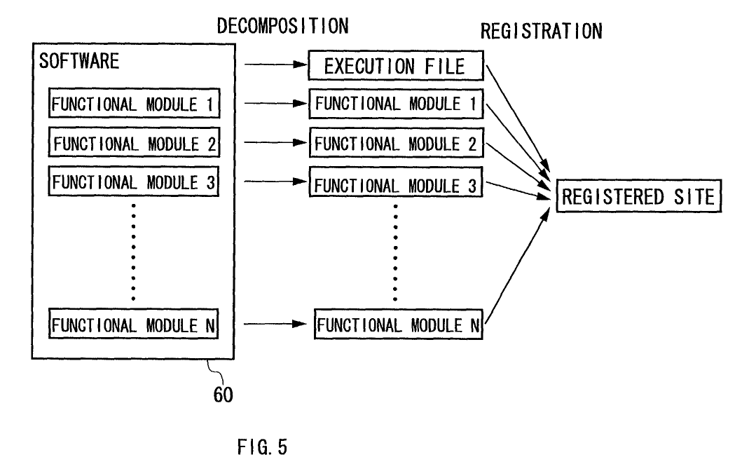

FIG. 5 shows a flow of the decomposition and registration of the software comprised of a plurality of functional modules. The software which contains a plurality of the functional modules is decomposed into a plurality of functional modules 1 to N and an execution file by the dividing unit 20. A plurality of the functional modules 1 to N and the execution file are then put together into a single registered site by the site registration unit 22. For example, the execution file is downloaded at the time of the first access and, from the second access on, the segment data as the functional modules are downloaded one at a time. The downloaded functional modules may be automatically installed every time the functional module is downloaded. Moreover, the functions of the software owned by the user may be version-updated every time the access is made to the registered site.

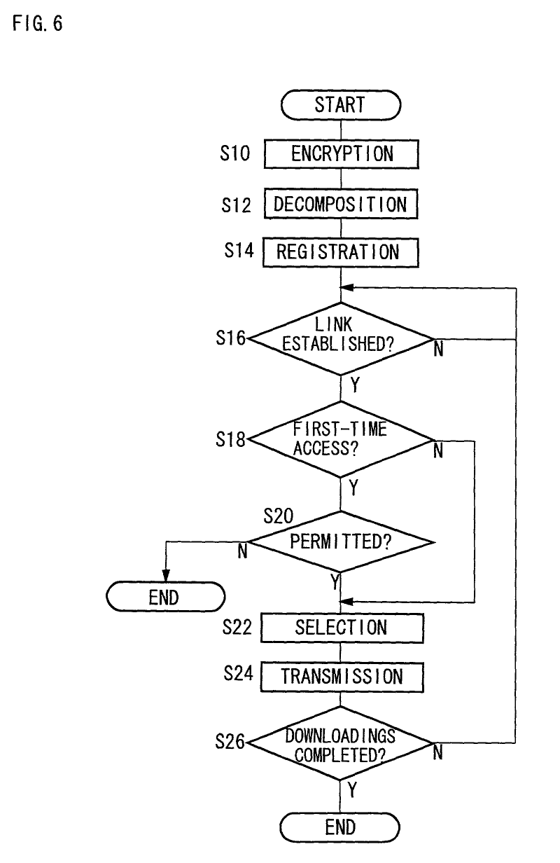

FIG. 6 is a flowchart showing an operational procedure of the software distributing server 14. Firstly, the encryption unit 18 encrypts the software (S10). Next, the dividing unit 20 decomposes the encrypted software into a plurality of segment data (S12). Then, the site registration unit 22 registers a plurality of the segment data in a site (S14). Next, the link monitor 30 supervises a link state between the site and the user terminal 12 (S16, S16N). When a link is established between the user terminal 12 and the site (S16Y), whether or not the access from this user terminal 12 is made for the first time is judged (S18). When the access is made for the first time (S18Y), the transmission permit-deny confirming unit 28 confirms with the user about permission or denial of the transmission (S20). If the user permits the transmission (S20Y, S18N), the data selector 26 selects unsent data from a plurality of the segment data. The selected data are transmitted to the user terminal 12 via the data transmit-receive unit 32 (S24). The procedures from S16 through S24 will be repeated until transmission of all segment data has been completed (S26).

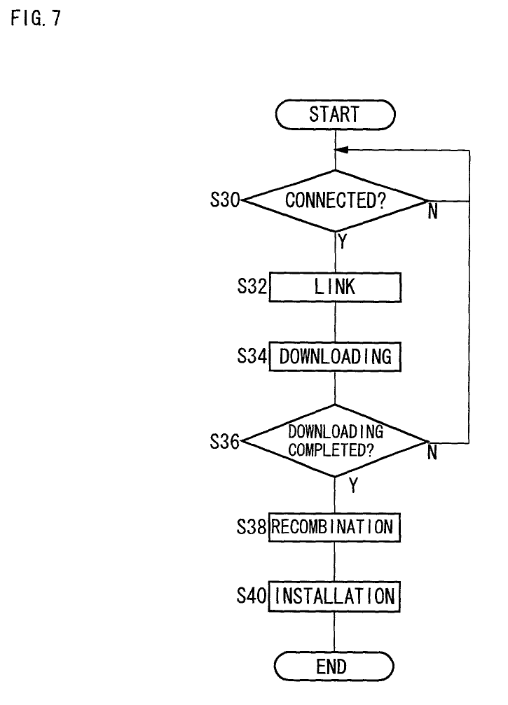

FIG. 7 is a flowchart showing an operational procedure of the user terminal 12. Firstly, the connection monitor 44 monitors a connection state between the user terminal 12 and the Internet (S30). When the user terminal 12 is connected to the Internet (S30Y), a link is established by the link processor 42 (S32). When the link is established, a single set of segment data is downloaded by the data receiving unit 40 (S34). The procedures from S30 through S34 are repeated until the downloading of all segment data are completed (S36). When all of the segment data are downloaded (S36Y), those segment data are recombined by the installation processor 46 (S38). Thereafter, the thus recombined software is installed by the installation processor 46 (S40).

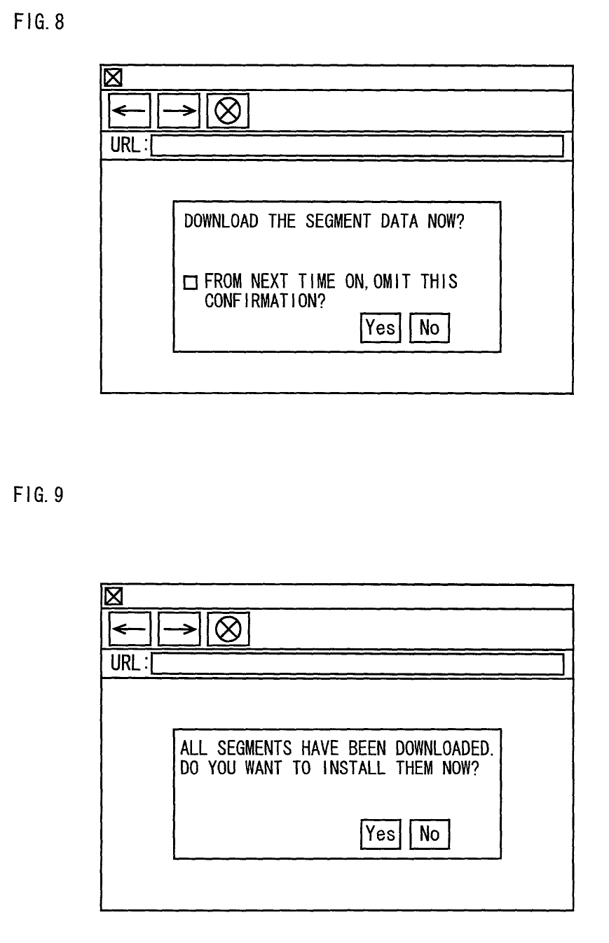

FIG. 8 is a screen example, displayed on the user terminal, to confirm with the user whether or not transmission of the segment data is permitted. When all of the segment data are not transmitted or the access is made for the first time, this confirmation screen will be displayed. Moreover, when the access is made to the registered site from the next time on, whether or not the user wishes to omit a confirmation window may be also confirmed then. When the user clicks on “Yes”, the downloading of the segment data is started. Moreover, “From next time on, omit this confirmation” is checked with a mark indicating “Yes”, the segment data will be downloaded without being notified to the user, from the next time on.

FIG. 9 is a screen example, displayed on the user terminal 12, to confirm whether or not the installation of software is permitted. After all segment data have been downloaded, this screen will be displayed. When the user clicks on “Yes”, the recombined software is automatically installed in the user terminal 12. The display of the screen notifies the user that the downloading of all segment data has been completed. The preferred embodiments described above utilize a method in which the user is almost unaware of the downloading, so that there is no wonder if the user does not notice at all the completion of the downloading. Thus, notifying the user of the completion of the downloading can be safely said to effectively complete the above method.

The present invention has been described based on the embodiments which are only exemplary. It is understood by those skilled in the art that there exist other various modifications to each component and the combination of each processing described and that such modifications are encompassed by the scope of the present invention. Such the modifications include the following.

Though in the above-described embodiments the software distributing server 14 itself is equipped with the functions of the WWW server including the data storage 24, these functions may be realized by a server other than the software distributing server 14. This another server is connected to the software distributing server 14 via the Internet.

Moreover, a plurality of the segment data may be registered over a plurality of sites, and may also be registered over a plurality of Web pages included in these sites. The registered sites or related sites may have arbitrary physical or virtual structures.

Though in the above-described embodiments the link between the user terminal and the registered site is established when the user terminal gets connected to the Internet, the user terminal may get connected to the software distributing server 14 via LAN, wireless network and the like. Moreover, a substitute-like server which is connected to the software distributing server 14 via network such as the Internet, may download software collectively, so that the substitute server may distribute the segment data to the user terminal 12.

In the user terminal 12, the functions to download the segment data may be realized in the form of Internet browser software or ftp software installed in the user terminal 12. Moreover, the downloaded segment data may be in the form of CGI, applets or the like which is operable in the user side.

The user terminal may be structured such that a software downloading form is selectable between a segment form or a non-segment form. Thus, the user can download data in an environment most suitable for the user.

According to the present embodiments, the user's convenience for the downloading of data can be significantly increased.

Although the present invention has been described by way of exemplary embodiments, it should be understood that many changes and substitutions may be made by those skilled in the art without departing from the spirit and the scope of the present invention which is defined by the appended claims.

What is claimed is:

1. A method of distributing software to a user terminal, comprising:
decomposing the software into a plurality of recombinable segment data;
registering a plurality of the segment data to a predetermined site;
detecting linkage of the user terminal to the site; and
transmitting each of a plurality of the segment data to the user terminal in a sequence every time the linkage is detected.

2. An apparatus for distributing software to a user terminal, comprising:
a dividing unit which decomposes the software into a plurality of recombinable segment data;
a site registration unit which registers a plurality of the segment data to a predetermined site;
a link monitor which supervises a link state between the user terminal and the site; and
a data transmission unit which selects unsent data from a plurality of the segment data every time the user terminal is linked to the site, and transmits the unsent data to the user terminal.

3. An apparatus according to claim 2, further comprising an encryption unit which encrypts the software,
wherein said dividing unit decomposed the encrypted software into a format of segment data such that the software is allowed for installation only when all segment data are recombined.

4. An apparatus according to claim 2, wherein said dividing unit subdivides the software into a data size to the degree that the user is unaware of the downloading thereof, and
wherein said data transmission unit transmits a plurality of the segment data to the user terminal without notifying the user terminal of the data transmission.

5. An apparatus according to claim 3, wherein said dividing unit subdivides the software into a data size to the degree that the user is unaware of the downloading thereof, and
wherein said data transmission unit transmits a plurality of the segment data to the user terminal without notifying the user terminal of the data transmission.

6. An apparatus according to claim 2, wherein when the user terminal is linked to the site, said link monitor confirms with a user as to whether or not transmission of a plurality of the segment data is permitted.

7. An apparatus according to claim 3, wherein when the user terminal is linked to the site, said link monitor confirms with a user as to whether or not transmission of a plurality of the segment data is permitted.

8. An apparatus according to claim 4, wherein when the user terminal is linked to the site, said link monitor confirms with a user as to whether or not transmission of a plurality of the segment data is permitted.

9. An apparatus according to claim 2, wherein said site registration unit registers each of a plurality of the segment data to a plurality of Web pages included in the site in a distributed manner.

10. An apparatus according to claim 3, wherein said site registration unit registers each of a plurality of the segment data to a plurality of Web pages included in the site in a distributed manner.

11. An apparatus according to claim 4, wherein said site registration unit registers each of a plurality of the segment data to a plurality of Web pages included in the site in a distributed manner.

12. An apparatus according to claim 6, wherein said site registration unit registers each of a plurality of the segment data to a plurality of Web pages included in the site in a distributed manner.

13. A user terminal, comprising:
a link processor which establishes a link with a registered site of a plurality of segment data, every time the user terminal is linked to a network, where software is decomposed in a recombinable format; and
a data receiving unit which downloads from the registered site at least a single set among a plurality of the segment data.

14. A user terminal according to claim 13, wherein said link processor establishes a link with the registered site every time the user terminal accesses any of a plurality of Web pages included in a predetermined related site.

15. A user terminal according to claim 13, further comprising:
a data storage which stores installed software; and
an installation processor which, when said data receiving unit downloads all of a plurality of the segment data, recombines the segment data and installs the recombined segment data to said data storage.

16. A user terminal according to claim 14, further comprising:
a data storage which stores installed software; and
an installation processor which, when said data receiving unit downloads all of a plurality of the segment data, recombines the segment data and installs the recombined segment data to said data storage.

17. A user terminal according to claim 13, wherein the segment data to be downloaded by said data receiving unit is in a form operable at user side.

18. A user terminal according to claim 13, wherein a downloading form is selectable between a segment form and a non-segment form according to a user's environment.
